(19) United States
(12) Patent Application Publication
(10) Pub. No.: US 2024/0186729 A1
(43) Pub. Date: Jun. 6, 2024

(54) FASTENING BOLT

(71) Applicant: BROSE SITECH GMBH, Wolfsburg (DE)

(72) Inventor: Nicolas BECKER, Lehre (DE)

(21) Appl. No.: 18/553,162

(22) PCT Filed: Mar. 14, 2022
(86) PCT No.: PCT/EP2022/056530

§ 371 Date: Sep. 28, 2023

(30) Foreign Application Priority Data
Mar. 31, 2021 (DE) 10 2021 108 223.4

(51) Int. Cl. H01R 11/05; H01R 4/26; H01R 4/30; H01R 4/66

(52) U.S. Cl. CPC H01R 11/05; H01R 4/26; H01R 4/308; H01R 4/66

(57) ABSTRACT

The invention relates to a fastening bolt (10, 10′) comprising a fastening bolt head and a fastening bolt shank (13).

It is provided that the fastening bolt head and/or the fastening bolt shank (13) have/has two fastening elements (11; 12, 12′) arranged substantially in two planes (E1, E2) spaced apart from each other, between which a structural part plane (E3) is formed in which, in an assembled state, a structural part (100) is located to which the fastening bolt (10, 10′) is fastened.

The invention relates to the connection of a cable, in particular a ground cable, to a metallic structural part, in particular a seat pan, which has an electrically conductive connection part at the end.

DE 10 2017 011 718 A1 describes a clamp for at least temporary fastening of a cable lug resting by means of a first surface of an eyelet section on a polygonal head of an ground bolt, wherein the clamp, in axial view corresponding to the longitudinal axis of the ground bolt, is a substantially U-shaped element which is designed to partially surround the circumference of the polygonal head and of the eyelet section resting thereon and, in the region of the border, to engage positively at least in sections on the polygonal head and on the eyelet section of the cable lug. The shank of the ground bolt extends through an opening in the eyelet section. The polygonal head is preferably electrically conductively connected to a body part via a spacer.

DE 10 2008 010 352 A1 discloses a holding arrangement for at least two electrical connection members, such as cable lugs, which each have an electrical connection section and a line section, respectively, having a base part and a cover part which can be connected to the base part to form a holding device, the connecting sections being inserted axially one above the other in the holding device and being fastened axially, and the line sections extending in the radial direction opposite radial openings of the holding device, wherein the radial openings are formed in such a way that the connecting sections cannot be pulled out of the radial openings, wherein an axial opening is also formed on the base part and/or the cover part, via which opening at least one connecting section of the inserted connecting sections can be electrically contacted, wherein the holding device has centring means for centring the connecting sections in the holding device and wherein the centring means engage on the outer circumference of the connecting sections.

EP 2 009 744 A1 concerns a fastening system for fastening a cable lug in a motor vehicle, which comprises a fastening element that can be fastened to a complementary element secured at the vehicle and a disc with a central opening. The disc and the fastening element have a common axis of symmetry and the disc is rotatably connected to the fastening element about this axis of symmetry. The disc is provided with latching elements by means of which it can be latched to a cable lug in a rotationally fixed manner.

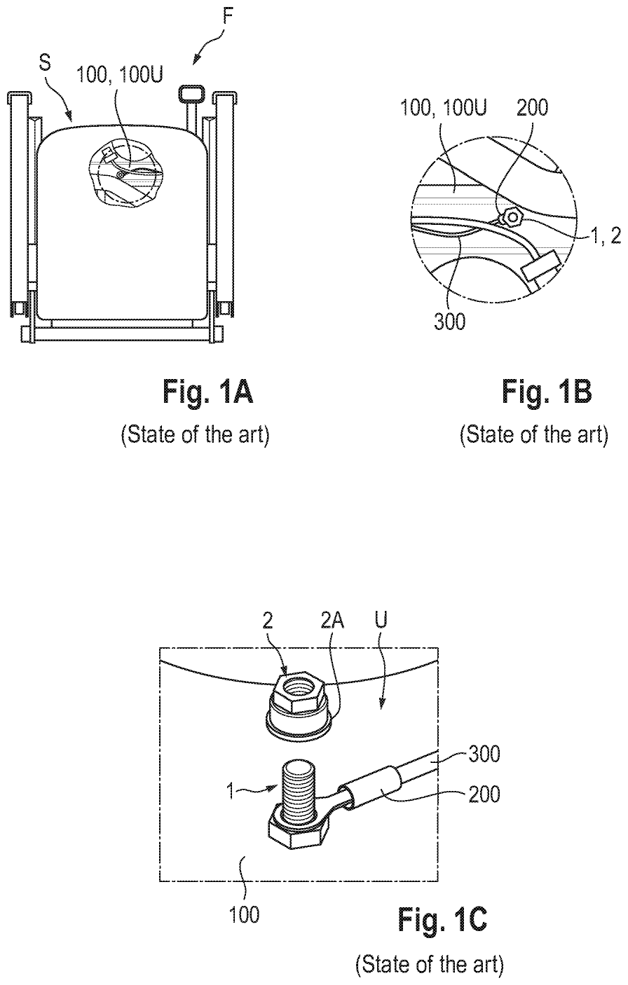

The starting point of the present invention is (compare FIG. 1A) the connection of a cable, in particular an ground cable, to a metallic structural part, in particular a seat pan, which has an electrically conductive connecting part at the end, see FIGS. 1B and 1C, in particular a cable lug or a cable eye.

FIGS. 1A, 1B and 1C show the conventional prior art. They show FIG. 1A a bottom side of a structural part of a vehicle seat in the assembled state;

FIG. 1B an enlarged view of a conventional ground contact on the bottom side of the structural part in the assembled state, extracted from FIG. 1A;

FIG. 1C a perspective view of the conventional ground contact on the bottom side of the structural part according to FIGS. 1A and 1B in the not yet fully assembled state.

A ground bolt 1 with an external thread is welded to the structural part 100, in particular the seat pan, and a nut 2, in particular a hexagonal nut, is screwed onto the ground bolt 1 by means of the nut 2 after the connecting part 200 (cable holder) has been placed on the ground bolt 1. The known procedure is explained even more in principle in that, in order to establish a stable ground contact, a ground bolt 1 or a nut 2 is welded onto a structural part, in particular of a vehicle body, so that the ground bolt 1 or the nut 2 is electrically conductively connected to the sheet metal of the structural part 100. The connecting part 200, such as the cable lug, is then electrically connected to the ground bolt 1 or to the nut 2 by screwing a nut 2 onto the ground bolt 1 or by screwing an ground bolt 1 into the nut 1.

According to the present invention, the structural part 100 is a seat pan of a seat part S of a vehicle seat F made of a thin sheet metal, which is shown from its bottom side U in the FIG. 1.

In this conventional embodiment, aspects to be improved arise in that the nut 2 covering the external thread of the ground bolt 1 arranged on the structural part 100, in particular the seat pan, in particular previously welded on, which is also referred to as a welding bolt, must be dismantled again during a final assembly so that the ground cable or also a cable with a different function, as explained above, can be screwed on.

The nut 2 covering the external thread of the ground bolt 1 (which is used to conduct the grounding current from the structural part 100 via the ground cable to the vehicle body (not shown)) is already pre-assembled before final assembly, as the structural part 100 is coated, wherein cathodic dip painting in particular is provided as the coating process. In order that the ground bolt 1, which has previously been welded to the structural part 100, is not coated as well, the externally thread-covering nut 2 must be removed again in a disadvantageous manner for final assembly of the cable 300 after the ground bolt 1 and the nut 2 have been coated together. In addition, the ground bolt 1 is always arranged in this approach in a disadvantageous manner, although it is not needed at all in some vehicle seats where no grounding current has to be dissipated. This means that an individual arrangement of a ground bolt to form a ground contact only when needed is not possible with this known solution.

It was considered to mount the ground bolt 1 only during the final assembly, with the advantage that the ground bolt 1 cannot be damaged, in particular bent, for example, during transport of the coated structural part 100 to the final assembly. However, since the final assembly of the components, in particular the ground cable, takes place from the bottom side U of the structural part 100, an assembly of the ground bolt 1 penetrating the structural part 100 from only one side of the structural part 100 is unfavourable for the worker in series production, so that a solution is sought which avoids the disadvantages mentioned and enables an individual production of a ground contact.

The object of the invention is thus to create an improved assembly of a bolt, in particular a ground bolt for the arrangement of a cable, in particular a ground cable, so that, if required, a structure-part-side arrangement of an electrically conductive contact, in particular a ground contact, can take place in a simple manner.

The starting point of the invention is a fastening bolt which has a fastening bolt head and a fastening bolt shank.

According to the invention, it is provided that the fastening bolt head and/or the fastening bolt shank comprises two fastening elements arranged substantially in two planes spaced apart from each other, between which a structural part plane is formed in which, in an assembled state, a structural part is located to which the fastening bolt is fastened.

In an advantageous way, the fastening bolt has its own fastening elements, so that a novel fastening of the fastening bolt is possible, which is explained in more detail in the description.

In a preferred embodiment variant, the fastening bolt is provided in one part, wherein the two fastening elements are arranged on the fastening bolt head and/or the fastening bolt shank. A one-part design advantageously simplifies the assembly of the fastening bolt on the structural part and all required parts are arranged in an advantageous manner so that they cannot be lost.

In another preferred embodiment, the fastening bolt is in two parts, wherein a second fastening element of the two fastening elements is reversibly arranged separately in a form-fitting manner on the fastening bolt head and/or the fastening bolt shank. This solution simplifies the manufacture of the fastening bolt, since each part taken separately can be manufactured more simply, and possibly more cheaply, compared to the fastening bolt of the first embodiment variant.

Preferably, according to the first one-part embodiment variant of a fastening bolt, it is provided that the two fastening elements are wing-like fastening segments and wing-like fastening counter segments radially extending from the fastening bolt head and/or the fastening bolt shank with respect to a fastening bolt longitudinal axis.

In the preferred second two-part embodiment variant of a fastening bolt, it is provided that the two fastening elements are likewise wing-like fastening segments extending radially from the fastening bolt head and/or the fastening bolt shank with respect to the longitudinal axis of the fastening bolt, but in contrast to the first one-part embodiment, the second fastening element is a ring-like fastening counter-segment.

In both embodiment variants, the wing-like fastening segments in particular advantageously allow the first fastening element to be inserted through the structural part and fastened thereto, while the wing-like fastening counter segments advantageously form counter bearings and thus advantageously form a kind of sandwich, since, in the assembled state, the structural part is arranged between the fastening elements (in the first plane) and the fastening counter-segments (located in the second plane), respectively, in both embodiment variants of the fastening bolts, as explained in more detail in the description.

According to the invention, several design variants are possible with respect to the arrangement of at least one stop and/or at least one cutting element.

In a first embodiment variant, a stop and at least one cutting element are arranged on the surface of at least one of the wing-like fastening segments directed to the structural part plane.

In a second embodiment variant, on the surfaces of two wing-like fastening segments directed to the structural part plane, a stop is arranged on one of the wing-like fastening segments and at least one cutting element is arranged on the other one of the wing-like fastening segments.

In a third embodiment variant, both at least one stop and at least one cutting element are arranged on the surfaces of the at least two wing-like fastening counter-segments directed to the structural part plane.

In a preferred further embodiment, at least one locking element is arranged in an advantageous manner for securing the position of the fastening bolt in its initial position on the surfaces of the wing-like fastening counter-segments or the ring-like fastening counter-segment directed to the structural part plane, as explained in more detail in the description.

Preferably, it is provided that the at least one cutting element and/or the at least one locking element are designed as ramps, the advantages of this embodiment being explained in more detail in the description.

The invention thus relates to a fastening arrangement for fastening a bolt, in particular a ground bolt, which is characterised in that the fastening arrangement comprises a receiving opening in a structural part and a fastening bolt according to at least one of the aforementioned embodiment variants and the associated preferred features, which has two fastening elements in planes substantially spaced apart from one another, by means of which the fastening bolt can be reversibly fastened in the receiving opening of the structural part located in the structural part plane.

A method for fastening the fastening bolt in the receiving opening of the structural part is also an object of the invention, wherein the fastening bolt has the two fastening elements in two planes substantially spaced apart from each other, by means of which the fastening bolt can be reversibly fastened in the receiving opening of the structural part located in the structural part plane.

The method, in particular the assembly method, according to the invention comprises the following essential steps, which are further explained and subdivided in the description:
a) pre-positioning and inserting the wing-like fastening segments of the fastening bolt arranged in the first plane from one side of the structural part into the receiving opening until the fastening counter-segments located in the second plane rest against the structural part and the structural part is arranged in the structural part plane between the two planes,
b) rotating the fastening bolt from the same side of the structural part,
   whereby the wing-like fastening segments of the fastening bolt engage behind the structural part in the first plane, the fastening counter-segments located in the second plane forming counter-bearings on the opposite side of the structural part,
   until at least one stop extending into the structural part plane, which is arranged on at least one of the wing-like fastening segments, abuts against a front side portion of the structural part within the front side of the receiving opening,
   wherein at least one cutting element, which extends into the structural part plane and is arranged on at least one of the wing-like fastening segments, simultaneously cuts open a coating of the structural part during the rotary movement thereby forming an electrical contact with the metallic structural part.

Preferably, it is possible in an advantageous manner that not only the fastening bolt according to the two embodiment variants can be mounted in the described manner, but steps a) and b) are carried out after a cable provided with a connecting part is previously arranged on the fastening bolt shank and secured by means of a nut/disc connection.

In an advantageous manner, it is thereby possible that a fastening bolt unit consisting of fastening bolt, cable, in particular a ground cable and the nut/disc connection can be reversibly mounted on the fastening bolt according to steps a) and b), as explained in more detail in the description.

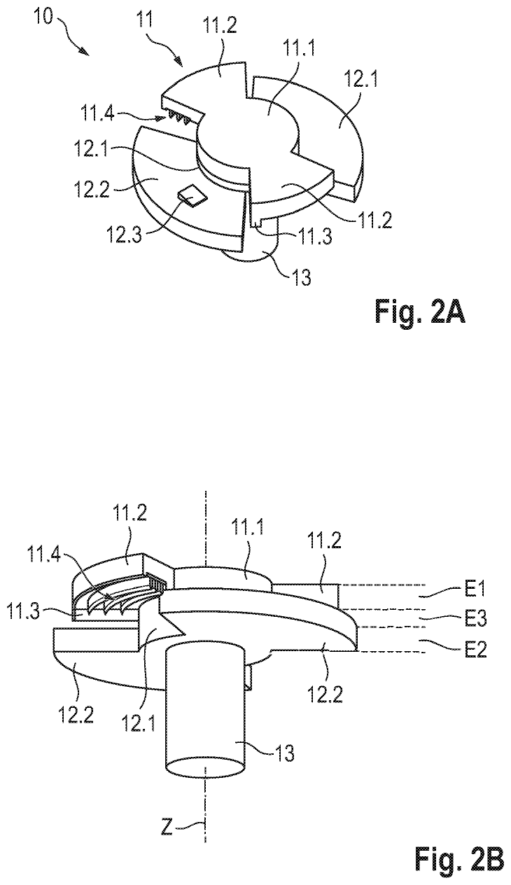

The invention is explained in detail below with reference to FIGS. 2A to 4D. They show:

FIG. 2A the fastening bolt (without cable) according to a first one-part embodiment variant in a perspective view obliquely from above;

FIG. 2B the fastening bolt according to FIG. 2A in a perspective view obliquely from below;

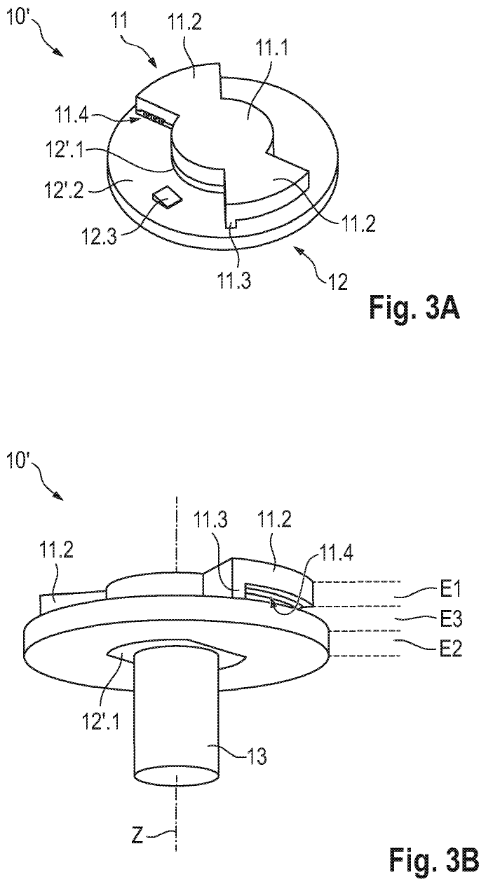

FIG. 3A the fastening bolt (without cable) according to a second two-part embodiment variant in a perspective view obliquely from above;

FIG. 3B the fastening bolt according to FIG. 3A in a perspective view obliquely from below.

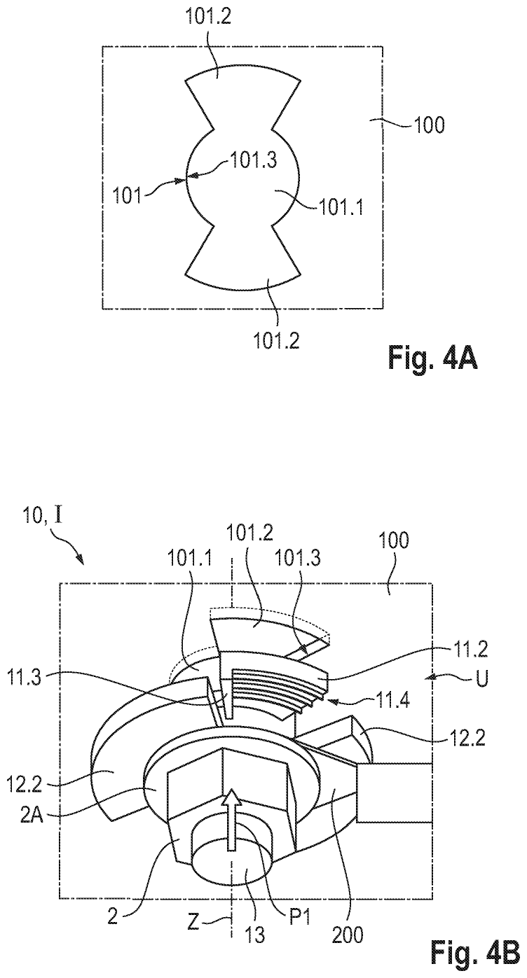

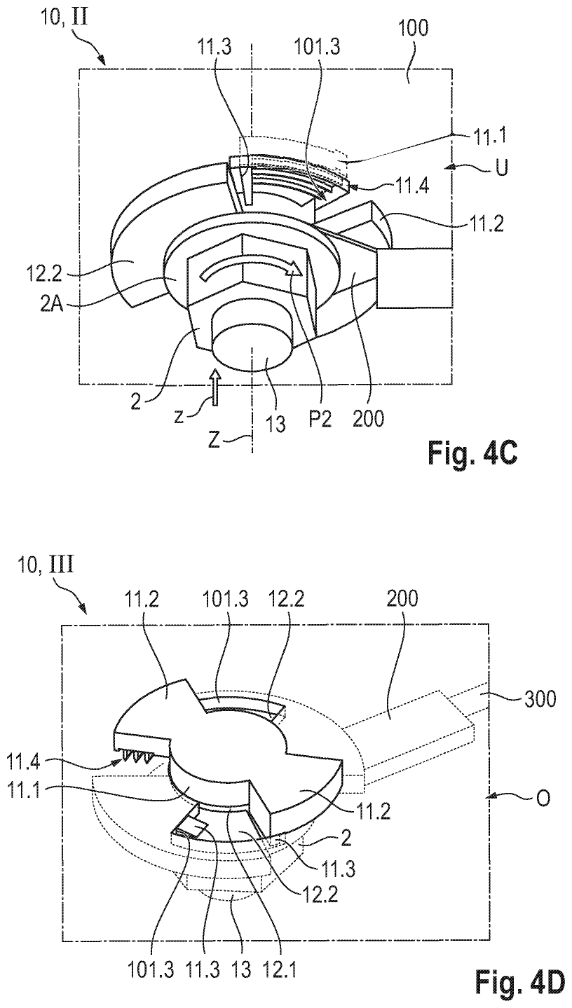

FIG. 4A a representation of a receiving opening according to the invention in a structural part, seen from the bottom side of the structural part;

FIG. 4B the fastening bolt according to the invention (according to the first one-part embodiment variant) with an already pre-assembled cable (in a perspective view obliquely from below) in a first assembly position, which is pre-positioned on the bottom side of the structural part in the first assembly position;

FIG. 4C the fastening bolt according to the invention as shown in FIG. 4B with the already pre-assembled cable (in a perspective view obliquely from below) in a second assembly position, which is inserted into the receiving opening as shown in FIG. 4A starting from the bottom side of the structural part and is pre-positioned in the second assembly position in the structural part;

FIG. 4D the fastening bolt according to the invention as shown in FIG. 4B with the already pre-assembled cable (in a perspective view obliquely from above) in a final assembly position in the structural part.

FIG. 4A shows a representation of a receiving opening 101 according to the invention in a structural part 100, seen from the bottom side U of the structural part 100.

It is understood that the structural part 100 accordingly has an upper side O which, in the embodiment example, is directed towards an occupant sitting on the padded seat pan of the seat part S of the vehicle seat F.

The receiving opening 101 of the structural part 100 has a specific inner contour corresponding to an outer contour of a first fastening element 11 of a fastening bolt head of a fastening bolt 10, 10′, wherein FIGS. 2A and 2B show a first embodiment variant of the fastening bolt with reference numeral 10 and FIGS. 3A and 3B show a second embodiment of the fastening bolt with reference numeral 10′.

The first fastening element 11 of the respective fastening bolt head of the fastening bolt 10, 10′ does not differ in the two embodiment variants, so that the following description applies to both embodiment variants.

The first fastening element 11 has a cylindrical outer contour as a base section 11.1 starting from a fastening bolt longitudinal axis Z (FIG. 2B), from which wing-like fastening segments 11.2 protrude orthogonally with respect to the longitudinal axis Z.

The two second fastening elements 12, 12′ form at least one fastening counter-segment 12.2, 12′.2, wherein the fastening counter-segment(s) 12.2, 12′.2 is/are differently formed depending on the embodiment variants, which will be discussed later.

First of all, it is essential that the first fastening element 11 with its fastening segments 11.1 and 11.2 is arranged in a first x/y plane E1.

The respective second fastening element 12, 12′ is arranged with its fastening counter-segments 12.2 and its fastening counter-segment 12′.2, respectively, also in an x/y plane which lies parallel to the first x/y plane E1 and is hereinafter referred to as the second x/y plane E2.

In the intermediate x/y plane, which is referred to as the third x/y structural part plane E3, the sheet metal of the structural part 100 is located in the assembled state, to which the respective fastening bolt 10, 10′, in the sense of fastening the respective fastening bolt 10, 10′ to the sheet metal, is fastened.

The fastening segments 11.1 and 11.2 of the first fastening element 11 are clamped with their bottom sides to the upper side of the sheet metal and the fastening counter segments 12.2 are clamped with their upper sides and the fastening counter segment 12′.2 is clamped with its upper side 2 to the bottom side of the sheet metal, so that finally the respective fastening bolt 10, 10′ (first and second embodiment variant) is fastened to the sheet metal.

In other words, the bottom side of the first fastening element 11 arranged in the first x/y plane E1 and the upper side of the respective second fastening element 12, 12′ arranged in the second x/y plane E2 are arranged at a predetermined distance from one another, which distance depends on the thickness of the structural part 100, hence on the sheet thickness of the structural part 100, which in the embodiment example is the seat pan sheet thickness.

The fastening elements 11, 12 of the fastening bolt 10 according to the first embodiment (FIGS. 2A, 2B): The second fastening element 12 has a cylindrical outer contour as a base section 12.1 starting from the fastening bolt longitudinal axis Z (FIG. 2B), from which two further orthogonal wing-like fastening counter-segments 12.2 project with respect to the longitudinal axis Z (similar to the first wing-like fastening segments 11.2).

The fastening counter-segments 12.2 of the second fastening element 12 form a flat surface on their upper sides directed to the first fastening element 11, with the exception of the at least one locking element 12.3. The bottom sides of the fastening counter-segments 12-2 of the second fastening element 12 also form a flat surface.

FIGS. 2A and 2B show that the first fastening segments 11.2 and the second fastening counter segments 12.2 are arranged on the cylindrical periphery of the base sections 11.1 and 12.1 in such a way that the fastening segments 11.2 and fastening counter segments 12.2 are offset from each other.

The lateral outer contour of the fastening segments 11.2 of the first fastening element 11 oriented towards the receiving opening 101 corresponds with the inner contour of the receiving opening 101 shown in FIG. 4A.

The lateral outer contour of the fastening counter segments 12.2 of the second fastening element 12 does not correspond with the inner contour of the receiving opening 101 shown in FIG. 4A.

At least one of the first fastening segments 11.2 has a stop 11.3 which projects in the direction of the longitudinal extension of a fastening bolt shank 13 from the at least one fastening segment 11.2 in the direction of the fastening bolt longitudinal axis Z. The at least one stop 11.3 has a certain length, which is dimensioned such that the stop 11.3 in the assembled state only projects into the third x/y structural part plane E3. The at least one stop 11.3 is arranged on the bottom side of one or both fastening segments 11.2, as is clear from FIGS. 2A, 2B.

The at least one stop 11.3 is in particular preferably arranged at the edge of the respective fastening segment 11.2, wherein the at least one stop 11.3 is arranged at that edge which, viewed counterclockwise according to FIG. 2A, is located furthest away from the next fastening segment 12.1 in the second x/y plane E2 of the second fastening element 12.

At least one of the first fastening segments 11.2 further comprises a cutting element 11.4, which projects in the direction of the longitudinal extension of a fastening bolt shank 13 from the at least one fastening segment 11.2 in the direction of the fastening bolt longitudinal axis Z. The at least one cutting element 11.4 has a certain length, which is dimensioned such that the cutting element 11.4 projects only slightly into the third x/y structural part plane E3 in the assembled state. The at least one cutting element 11.4 is arranged on the bottom side of one or both fastening segments 11.2, as is clear from FIGS. 2A, 2B.

By slightly is meant with respect to the length of the at least one cutting element 11.4 that the cutting element 11.4 in the end position, which will be explained later, does not or only slightly cut into the sheet metal of the structural part 100, but securely cuts or scores into a coating of the sheet metal so that there is electrical contact between the fastening bolt 10 and the structural part 100.

The at least one cutting element 11.4 is preferably designed as a type of toothing, wherein the teeth run in the circumferential direction with respect to the fastening bolt longitudinal axis Z, wherein it is preferably provided that the tooth height is designed to increase in the circumferential direction, wherein (compare FIG. 2) the tooth height on a side opposite the stop 11.3 on the bottom side of the fastening segment 11.2 has only a small amount which increases in the direction of the stop 11.3. The significance of this solution according to the invention will be discussed in more detail in connection with the assembly of the fastening bolt 10.

It is clear from FIGS. 2A and 2B that both a stop 11.3 and the cutting element 11.4 can be arranged in combination on one fastening segment 11.2 or both fastening segments 11.2 of the first fastening element 11. However, it is also possible that the stop 11.3 is arranged on one fastening segment 11.2 and the cutting element 11.4 is arranged on the other fastening segment 11.2. It is essential that at least one stop 11.3 and at least one cutting element 11.4 are arranged in the explained manner.

As already explained, the second fastening counter segments 12.2 are arranged circumferentially offset from the first fastening segments 11.2.

A locking element 12.3 is arranged on the upper side (compare FIG. 2A) of at least one of the fastening counter-segments 12.2, which protrudes slightly from the upper side as a raised contour and projects into the third x/y structural part plane E3 in the assembled state. Slightly means here that the predeterminable maximum distance amount of the locking element 12.3 is at most the sheet thickness or a partial amount of the sheet thickness of the structural part 100.

It is clear from FIG. 2A that the locking element 12.3 is formed as a ramp, so that the predetermined distance amount is only reached at the end of the ramp. In other words, the locking element 12.3 forms a step at the end which serves to lock the fastening bolt 10 (position lock) in its end position. In this case, the at least one locking element 12.3 is arranged in exactly one position on the upper side of the fastening counter-segment 12.2 of the second fastening element 12, so that in the end position of the fastening bolt 10, the step engages in a locking manner exactly on a front-side section of the sheet within the front side 101.3 of the receiving opening (compare FIG. 4A) of the structural part 100. It is understood that a locking element 12.3 can be arranged on at least one or both fastening counter-segments 12.2 in the manner described.

According to the invention, the fastening bolt 10 is made in one part. Preferably, it is a cold extruded part, i.e. the fastening bolt 10 is produced by extrusion, wherein such extruded parts are characterised by extremely high strength and special surface quality. In its final state, the fastening bolt shank 13 has the external thread, which is not shown in more detail, onto which a nut 2 can be screwed.

The fastening elements 11, 12 of the fastening bolt 10 according to the first embodiment variant (FIGS. 3A, 3B):

As already mentioned, the first fastening element 11 according to the first embodiment variant is not different from the first fastening element 11 according to the second embodiment variant.

However, the second fastening element 12′ of the second embodiment variant differs from the second fastening element 12 of the first embodiment variant, as illustrated by FIGS. 3A and 3B.

The second fastening element 12 of the second embodiment variant is formed as a fastening counter-segment 12′.2 in the manner of a counter-bearing ring, wherein it is further provided that the fastening counter-segment 12′.2 represents a separate part.

That is, the fastening bolt 10′ is formed in two parts according to the invention. Preferably, the part of the fastening bolt 10 already described in connection with the first embodiment variant and the counter bearing ring are each manufactured separately, wherein both parts can be manufactured as cold extruded parts by extrusion with the advantages mentioned.

A two-part embodiment of the fastening bolt 10 avoids the undercuts formed in the first embodiment variant of the fastening bolt 10, which lead to a relatively costly manufacturing process.

Due to the two-part embodiment of the fastening bolt 10′, the position of the fastening counter-segment 12′.2, i.e. of the counter-bearing ring with respect to the fastening segments 11.2 of the first fastening element 11, is not set readily, so that according to the invention the base section 12′.1 of the counter-bearing ring on the fastening bolt shank 13 has a certain outer contour which (compare FIG. 3B) corresponds to the inner contour of the counter-bearing ring. In the assembled state, the counter bearing ring and the base section 12′.1 are connected in a form-fitting manner to each other via the contours, wherein the counter bearing ring is located in the second x/y plane E2. The contour of the base section 12′.1 is designed in such a way that the counter bearing ring assumes a specific position in which it is ensured that the locking element 12.3 (compare FIG. 3A), which is designed as a ramp analogous to the first embodiment, serves to lock the fastening bolt 10′ in its end position in accordance with the explanations for the first embodiment.

The fastening counter-segment 12′.2 of the second fastening element 12 forms a flat surface on its upper side (which is directed to the first fastening element 11), with the exception of the locking element 12.3. The bottom side of the fastening counter-segment 12′.2 of the second fastening element 12 also forms a flat surface.

After all this, the assembly will be discussed below, wherein the assembly steps differ only slightly from each other, wherein first the assembly of the fastening bolt 10 according to the first embodiment variant will be discussed with reference to FIGS. 4A to 4D. The differences to the assembly of the fastening bolt 10′ according to the second embodiment are then explained.

The base section 11.1 of the first fastening element 11 also forms the base section 12.1 of the second fastening elements 12, 12′, which differ according to the following explained embodiment variants of the first fastening bolt 10 (first embodiment variant) and the second fastening bolt 10′ (second embodiment variant).

The outer contours of the fastening segments 11.2 of the first fastening element 11 and of the base section 11.1 oriented towards the receiving opening 101 correspond with the inner contour of the receiving opening 101 shown in FIG. 4A, which has a receiving opening section 101.1 with a circular receiving inner contour analogous to the outer contour of the base section 11.1.

Furthermore, the receiving opening 101 has receiving opening sections 101.2 with a receiving inner contour which correspond to the outer contours, oriented towards the receiving opening 101, of the fastening segments 11-2 of the first fastening element 11.

The base section 11.1 and the fastening segments 11.2 of the first fastening element 11 form a flat surface on their upper side. The bottom sides of the fastening segments 11-2 of the first fastening element 11, which are directed to the second fastening element 12, also form flat surfaces with the exception of the at least one cutting element 11.4 and the at least one stop 11.3.

In FIG. 4B, the fastening bolt 10 in the one-part embodiment variant with an already preassembled cable 300 is shown in a perspective view obliquely from below in a first assembly position, wherein the fastening bolt 10 is arranged pre-positioned on the bottom side U of the structural member 100 in the first assembly position I.

It can be seen that in the first assembly variant shown, the fastening bolt 10 and the cable 300 are already pre-assembled on the fastening bolt shank 13 with a nut/disc connection 2, 2A. It is provided that the connecting part 200 of the cable 300 is already firmly tightened on the external thread of the fastening bolt shank 13. The pre-assembled so-called fastening bolt unit shown can thus be grasped as a whole by a worker and inserted into the receiving opening 101 according to the arrow P1, wherein insertion is only possible in the position according to FIG. 4B or by 180° about the fastening bolt longitudinal axis Z due to the contour specification. If the outer contours of the fastening counter segments 11.2 and the corresponding inner contours of the receiving opening sections 101.2 are formed differently in the structural part, it can even be ensured that only one insertion position is possible.

The worker presses the fastening bolt unit into the receiving opening 101 (compare FIG. 4C), wherein the upper side of the fastening counter segments 12.2 forms a stop, which can be felt by the worker, on the bottom side U of the sheet metal of the structural part 100. The locking element 12.3 arranged on the upper side of the fastening counter segments 12.2 is thereby pressed (not visible in FIG. 4C) against the bottom side of the sheet metal of the structural part 100, which moves out of the way of the locking element 12.3 by slight elastic deformation in this area.

FIG. 4C shows the fastening bolt unit according to the invention with the already pre-assembled cable 300 in a perspective view obliquely from below in a second assembly position II, which, starting from the bottom side U of the structural part 100, is inserted by the worker into the receiving opening 101 and thus pre-positioned in the second assembly position II in the structural part.

In the next step, a rotary movement of fastening bolt unit is performed about the fastening bolt axis Z in accordance with the arrow P2, during which all parts of the fastening bolt unit also rotate. The worker can, for example, grasp the nut 2 with an open-end spanner and rotate the fastening bolt unit about its longitudinal axis, wherein a force in the z-direction and a rotational force about the fastening bolt longitudinal axis Z are exerted by the worker until the stop (compare FIG. 4D) strikes against a front-side section of the sheet metal within the front side 101.3 of the receiving opening 101, while at the same time the locking element (compare FIG. 4D) engages with its step on another front-side section of the sheet metal on the front side 101.3 within the receiving opening 101.

The wing-like fastening segments 11.2 of the first fastening element 11 in the first x/y plane E1 engage behind the sheet metal of the structural part after the rotary movement P2 about the fastening bolt longitudinal axis Z in the area of the receiving opening 101, so that the sheet metal comes into the third x/y structural part plane E3 between the x/y planes E1 and E2 of the two fastening elements 11, 12.

FIG. 4D shows the fastening bolt unit according to the invention with the already pre-assembled cable 300 in a perspective view obliquely from above in a final assembly position III in the structural part 100 in which the first fastening element 11 is located outside the receiving opening. The sheet metal of the structural part 100 is located between the first fastening element 11 and the second fastening element 12, whose fastening counter segments 12.2 in the second x/y plane E2 support the sheet metal in the third x/y structural part plane E3 from below, so that the at least one cutting element 11.4 (without the sheet metal of the structural part 100 being able to move out of the way) can score the coating of the sheet metal of the structural part 100, wherein the tooth height of the at least one cutting element 11.4, which increases in the direction of rotation, ensures that the surface coating of the sheet metal is torn open to a continuously deeper depth. This advantageously ensures that the at least one cutting element 11.4 does not act on the sheet metal until part of the rotary movement P2 has taken place, so that the scoring takes place exclusively on the upper side of the sheet metal.

It is clear from the description that all steps can be carried out exclusively from the bottom side of the structural part 100, in particular the seat pan, which is seen as a significant advantage on the assembly line in terms of ease of assembly. In addition, it becomes clear that a vehicle seat is only equipped with the fastening bolt 10, 10′ of the first or second embodiment variant as required. Only the receiving opening 101 is always provided in all structural parts, so that an as-needed equipment with the fastening bolt 10, 10 or the respective fastening bolt unit can only be performed on the final assembly line.

The fastening bolt 10′ can also be pre-assembled to a fastening bolt unit, so that according to the previous description there is no difference in the actual final assembly of the fastening bolt 10′ or the fastening bolt unit with the fastening bolt 10. In the case of the fastening bolt unit with fastening bolt 10′ according to the second embodiment variant, the counter bearing ring is pre-assembled in a form-fitting manner as the second fastening element 12 and the nut/disc connection 2, 2A is pre-assembled in a form-fitting manner by screwing on as described It is understood that the assembly for both embodiment variants of the fastening bolts 10, 10′ can also be carried out in such a way that the fastening bolt 10, 10′ is set and fastened in the final assembly position III and only then the connecting part 200 of the cable 300 and the nut/disc connection 2, 2A are put on and the cable 300 is secured to the fastening bolt shank 13. In this case, during the assembly of the fastening bolt 10, 10′, the nut 2 is missing, which may be engaged by a tool in order to turn the fastening bolt 10, 10′ into the final assembly position III. It is therefore suggested that, for example, a provision is prepared on the fastening bolt shank 13 on which an open-end spanner or a special tool provided for this purpose engages, so that the fastening bolts 10, 10′ can be turned into their final assembly position III with the aid of this tool.

The disassembly of the fastening bolts 10, 10′ or of the fastening bolt units is also easily possible (in the case of fastening bolt units) by loosening the nut 2 and disengaging the locking element 11.3 by pressing on the locking element 11.3, wherein this step can be carried out from the upper side O of the structural part 100 by pressing and rotating against the direction of rotation P2.

The invention thus enables reversible subsequent assembly of a ground bolt on a painted structural part 100, which is only accessible from one side during assembly. Within the final assembly, there is a cost reduction, since only the fastening bolt 10, 10′ or the fastening bolt units have to be assembled, wherein the assembly can also be carried out variably only when they are also required in the complete seat. The fastening bolt 10, 10′ can be easily mounted reversibly, wherein in particular the simultaneous cutting of the coating by means of the at least one cutting element 11.4 and the contacting of the cutting element 11.4 of the metal structure achieved thereby is ensured and thus in a preferred embodiment the discharge of a grounding current in a desired manner is ensured.

### LIST OF REFERENCE SIGNS

### State of the Art

100 Structural part
200 Connecting part
300 Cable
1 Ground bolt
2 Nut
2A Disc

### Invention

100 Structural part
F Vehicle seat
S Seat part
U Bottom side
O Upper side
101 Receiving opening
101.1 Receiving opening section
101.2 Receiving opening sections
101.3 Front side
200 Connecting part
300 Cable

### First Fastening Bolt

10 Fastening bolt (first embodiment variant)
11 First fastening element
11.1 Base section
11.2 Fastening segments
11.3 Stop
12 Second fastening element
12.1 Base section
12.2 Fastening counter segments
12.3 Locking element

### Second Fastening Bolt 10′:

10′ Fastening bolt (second embodiment variant)
11 First fastening element
11.1 Base section
11.2 Fastening segments
11.3 Stop
12′ Second fastening element
12′.1 Base section
12′.2 Fastening counter segment
12.3 Locking element
Z Fastening bolt axis
E1 First x/y plane
E2 Second x/y plane
E3T Third x/y structural part plane
P1 Arrow P1 (insertion movement)
P2 Arrow P2 (rotary movement)
z Space direction
I First assembly position
II Second assembly position
III End position

1. Fastening bolt (10, 10′), which has a fastening bolt head and a fastening bolt shank (13), characterized in that the fastening bolt head and/or the fastening bolt shank (13) have/has two fastening elements (11; 12, 12′) which are arranged in two planes (E1, E2) spaced apart from one another, between which a structural part plane (E3) is formed in which, in an assembled state, a structural part (100) is located to which the fastening bolt (10, 10′) is fastened.

2. Fastening bolt (10) according to claim 1, characterised in that the fastening bolt (10) is in one part, the two fastening elements (11, 12) being arranged on the fastening bolt head and/or the fastening bolt shank (13).

3. Fastening bolt (10′) according to claim 1, characterised in that the fastening bolt is in two parts, wherein a second fastening element (12′) of the two fastening elements (11, 12′) is separately reversibly arranged in a form-fitting manner on the fastening bolt head and/or the fastening bolt shank (13).

4. Fastening bolt (10) according to claim 2, characterised in that the two fastening elements (11, 12) are wing-like fastening segments (11.2) and wing-like fastening counter segments (12.2) extending radially from the fastening bolt head and/or the fastening bolt shank (13) with respect to a fastening bolt longitudinal axis (Z).

5. Fastening bolt (10′) according to claim 3, characterised in that the two fastening elements (11, 12′) are wing-like fastening segments (11.2) and a ring-like fastening counter-segment (12′.2) extending radially from the fastening bolt head and/or the fastening bolt shank (13) with respect to a fastening bolt longitudinal axis (Z).

6. Fastening bolt (10, 10′) according to claim 4, characterized in that on the surface(s) directed towards the structural part plane (E3)
of at least one of the wing-like fastening segments (11.2) a stop (11.3) and at least one cutting element (11.4)
or
on one of the wing-like fastening segments (11.2) a stop (11.3) and on the other of the wing-like fastening segments (11.2) at least one cutting element (11.4)
or
on all wing-like fastening segments (11.2) at least one stop (11.3) as well as at least one cutting element (11.4)
are arranged.

7. Fastening bolt (10, 10′) according to claim 4, characterised in that at least one locking element (12.3) is arranged on the surface of the wing-like fastening counter-segments (12.2) or the ring-like fastening counter-segment (12′.2) directed towards the structural part plane (E3).

8. Fastening bolt (10, 10′) according to claim 6, characterised in that the at least one cutting element (11.4) and/or the at least one locking element (12.3) are formed as ramps.

9. Fastening arrangement for fastening a bolt, in particular a ground bolt, characterised in that the fastening arrangement comprises a receiving opening (101) in a structural part (100) and a fastening bolt (10, 10′) according to claim 1, which has two fastening elements (11, 12) essentially located in planes (E1, E2) which are spaced apart from one another and by means of which the fastening bolt (10, 10′) can be reversibly fastened in the receiving opening (101) of the structural part (100) located in the structural part plane (E3).

10. Method for fastening a fastening bolt (10, 10′) according to claim 1 in a receiving opening (101) of a structural part (100), the fastening bolt (10, 10′) having two fastening elements (11, 12) essentially located in planes (E1, E2) which are spaced apart from one another and by means of which the fastening bolt (10, 10′) can be reversibly fastened in the receiving opening (101) of the structural part (100) located in the structural part plane (E3), comprising the following steps:
a) pre-positioning and inserting the wing-like fastening segments (11.2) of the fastening bolt (10, 10′) arranged in the first plane (E1) from one side of the structural part (100) into the receiving opening (101) until the fastening counter-segments (12.2; 12′.2) located in the second plane (E2) rest against the structural part (100) and the structural part (100) is arranged in the structural part plane (E3) between the two planes (E1, E2), and
b) rotating the fastening bolt (10, 10′) from the same side of the structural part (10),
whereby the wing-like fastening segments (11.2) of the fastening bolt (10, 10′) engage behind the structural part (100) in the first plane (E1), the fastening counter-segments (12.2; 12′.2) located in the second plane (E2) forming counter-bearings on the opposite side of the structural part (100),
until at least one stop (11.3) extending into the structural part plane (E3), which is arranged on at least one of the wing-like fastening segments (11.2), abuts against a front side portion of the structural part (100) within the front side (101.3) of the receiving opening (101),
wherein at least one cutting element (11.4), which extends into the structural part plane (E3) and is arranged on at least one of the wing-like fastening segments (11.2), simultaneously cuts open a coating of the structural part (100) during the rotary movement (P2) thereby forming an electrical contact with the metallic structural part (100).

11. Method according to claim 10, characterised in that steps a) and b) are carried out after a cable (300) provided with a connecting part (200) has previously been arranged on the fastening bolt shank (13) and secured by means of a nut/disc connection (2, 2A), so that a fastening bolt unit consisting of fastening bolt (10, 10′), a cable (300), in particular a ground cable, and the nut/disc connection (2, 2A) can be reversibly mounted on the fastening bolt (10, 10′).
